(19) United States
(12) Patent Application Publication
(10) Pub. No.: US 2026/0358662 A1
(43) Pub. Date: Nov. 12, 2026

(54) BACKLIGHT UNIT, DISPLAY DEVICE AND DRIVING METHOD

(71) Applicant: LG Display Co., Ltd., Seoul (KR)

(72) Inventor: SeungTaek Oh, Paju-si (KR)

(21) Appl. No.: 19/671,262

(22) Filed: May 8, 2026

(30) Foreign Application Priority Data
May 9, 2025 (KR) 10-2025-0060167

(51) Int. Cl. G02F 1/1335

(52) U.S. Cl. CPC G02F 1/133626

(57) ABSTRACT

A display device, a driving method of the display device, and a backlight. The display device and the backlight include: a normal emission module including an optical area and a normal area surrounding the optical area; an optical emission module configured to be positioned in the optical area or the normal area; an optical sensor module configured to sense an external signal or external event through the optical area; and a position control device configured to position the optical emission module or the optical sensor module in the optical area.

### CROSS REFERENCE TO RELATED APPLICATION

This application claims priority from and the benefit of Korean Patent Application No. 10-2025-0060167, filed on May 9, 2025, which is hereby incorporated by reference for all purposes as if fully set forth herein.

### BACKGROUND

### Field

Embodiments of the invention relate generally to electronic devices, and more particularly, to a backlight unit, a display device, and a driving method of the backlight unit and/or the display device.

### Discussion of the Background

With the development of an information-oriented society, various needs for display devices for displaying images have increased. Recently, various types of display devices, such as liquid crystal display (LCD) devices, organic light emitting diode (OLED) display devices, and the like have been developed and widely used.

The above information disclosed in this Background section is only for understanding of the background of the inventive concepts, and, therefore, it may contain information that does not constitute prior art.

### SUMMARY

Display devices according to embodiments of the invention are capable of sensing an optical device in a display area by including a position control device, an optical emission module, and an optical sensor module.

Display devices according to embodiments of the invention are capable of being packaged with a reduced thickness while including a position control device, an optical emission module, and an optical sensor module.

Display devices according to embodiments of the invention are capable of improving quality of display images using a position control device, an optical emission module, and an optical sensor module.

Display devices according to embodiments of the invention are capable of improving quality of display images and being driven with low power using a position control device, an optical emission module, and an optical sensor module.

Additional features of the inventive concepts will be set forth in the description which follows, and in part will be apparent from the description, or may be learned by practice of the inventive concepts.

According to one or more embodiments of the invention, a display device includes: a backlight unit configured to provide backlight illumination; and a liquid crystal layer disposed over the backlight unit and including a plurality of liquid crystals whose arrangement is changeable. The backlight unit includes: a normal emission module including an optical area and a normal area surrounding the optical area; an optical emission module positioned in the optical area or the normal area; an optical sensor module configured to sense an external signal or external event through the optical area; and a position control device configured to control positions of the optical emission module and the optical sensor module and position the optical emission module or the optical sensor module in the optical area.

The position control device may be configured to position the optical emission module in the optical area in a first optical mode step, and position the optical sensor module in the optical area in a second optical mode step different from the first optical mode step.

The optical emission module of the backlight unit may be located closer to the optical sensor module than the normal emission module.

The position control device may further include a rail to which the optical emission module and the optical sensor module are fixed and a control motor configured to control a position of the rail.

The display device may further include: at least one normal pixel block located in the normal area; and at least one optical pixel block located in the optical area. The number of subpixels located in one optical pixel block may be less than the number of subpixels located in one normal pixel block.

The display device may further include a color filter layer disposed on the liquid crystal layer, the color filter layer including a plurality of color filters. The number of color filters located in the at least one optical pixel block may be less than the number of the color filters located in the at least one normal pixel block.

A planar shape of the optical emission module may be the same as a shape of a boundary between a plurality of the optical pixel blocks and a plurality of the normal pixel blocks.

A planar shape of the optical emission module may be the same as a planar shape of the optical area.

The display device may further include: an optical light source configured to emit light; an optical reflective sheet located on the optical light source and reflecting a direction of the light; an optical light guide plate located on the optical reflective sheet and diffusing the light; and an optical diffusion sheet located on the optical light guide plate and re-diffusing the light.

The optical sensor module may include a camera sensor or an infrared sensor. The normal emission module may include a backlight hole corresponding to the optical area. The optical sensor module may be overlapped with the backlight hole.

According to one or more embodiments of the invention, a driving method of a display device includes: a first optical mode step of positioning an optical emission module in an optical area and positioning an optical sensor module in a normal area surrounding the optical area; and a second optical mode step of positioning the optical sensor module being located adjacent to the optical emission module in the optical area and positioning the optical emission module in the normal area.

The first optical mode step may further include: a first position control step of positioning the optical emission module in the optical area; an optical emission module turn-on step of turning on the optical emission module; a first optical mode control step of compensating for luminance of the optical area; and an optical sensor module turn-off step of turning off the optical sensor module.

In the first position control step, a controller may control a position control device to allow the optical emission module to be positioned in the optical area.

In the first optical mode control step, an intensity of light emitted from a light source of the optical emission module may be less than an intensity of light emitted from a light source of a normal emission module located in the normal area.

In the first optical mode control step, a transmittance of a liquid crystal layer located in the optical area may be less than a transmittance of a liquid crystal layer located in the normal area.

The second optical mode step may further include: a second position control step of positioning the optical sensor module in the optical area; an optical emission module turn-off step of turning off the optical emission module; a second optical mode control step of controlling a transmittance of a liquid crystal layer of the optical area; and an optical sensor module turn-on step of turning on the optical sensor module.

In the second position control step, a controller may control a position control device to allow the optical sensor module to be positioned in the optical area.

In the second optical mode control step, a transmittance of the liquid crystal layer of the optical area may be controlled to be maximum. In the second position control step, the optical sensor module positioned in the optical area may be turned on in the optical sensor module turn-on step.

In the second optical mode control step, a transmittance of a portion overlapped with the color filter layer among portions of the liquid crystal layer of the optical area may be less than a transmittance of a portion not overlapped with the color filter layer among the portions of the liquid crystal layer of the optical area.

According to one or more embodiments of the invention, a backlight unit includes: a normal emission module including an optical area and a normal area surrounding the optical area; an optical emission module configured to be positioned in the optical area or the normal area; an optical sensor module configured to sense an external signal or external event through the optical area; and a position control device configured to control positions of the optical emission module and the optical sensor module in a structure where locations of the optical emission module and the optical sensor module are fixed to each other and position the optical emission module or the optical sensor module in the optical area.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 schematically illustrates the configuration of a display device according to embodiments of the invention.

FIG. 2 illustrates an equivalent circuit of a subpixel structure included in the display device according to embodiments of the invention.

FIGS. 3 and 4 illustrate configurations of the display device according to embodiments of the invention.

FIG. 5 is a plan view of a backlight unit according to embodiments of the invention.

FIG. 6 is a cross-sectional view taken along line A-B of FIG. 5.

FIGS. 7 and 9 are cross-sectional views taken along line C-D of FIG. 5.

FIGS. 8 and 10 illustrate structures of an area surrounding an optical area according to embodiments of the invention.

FIGS. 11 and 12 illustrate an area surrounding the optical area according to embodiments of the invention.

FIG. 13 is a flow chart illustrating a driving method of the display device according to embodiments of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

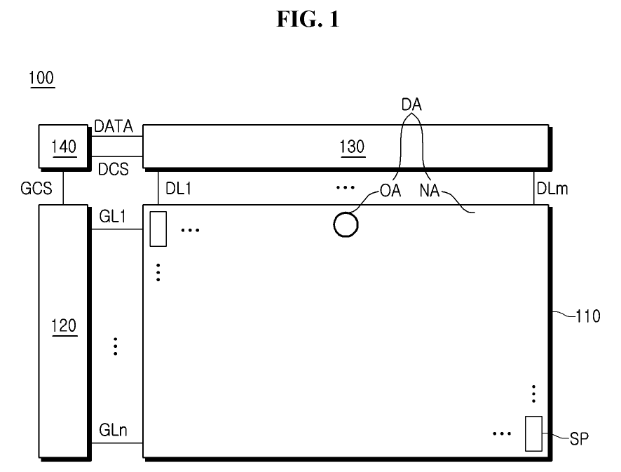

FIG. 1 schematically illustrates the configuration of a display device 100 according to embodiments of the invention.

Referring to FIG. 1, in one or more embodiments, the display device 100 may include a display panel 110 including a plurality of data lines DL, a plurality of gate lines GL, and a plurality of subpixels SP disposed in areas where the plurality of data lines DL and the plurality of gate lines GL intersect each other, a gate driver 120 configured to drive the plurality of gate lines GL, a data driver 130 configured to supply data voltages to the plurality of data lines DL, and a controller 140 configured to control the driving of the gate driver 120 and the data driver 130.

The gate driver 120 may sequentially supply scan signals (which may be referred to as “gate signals”) to the plurality of gate lines GL to sequentially drive the plurality of gate lines GL.

The gate driver 120 may sequentially supply a gate signal of an “on” voltage (which may be referred to as a” turn-on level voltage”) or an “off” voltage (which may be referred to as a “turn-off level voltage”) to the plurality of gate lines GL by the control of the controller 140. Thereby, the gate driver 120 may sequentially drive the plurality of gate lines GL.

The gate driver 120 may be located on one side or two opposing sides of the display panel 110 depending on a driving method.

The gate driver 120 may include at least one gate driver integrated circuit to drive a plurality of gate lines GL.

Each gate driver integrated circuit may be electrically connected to a bonding pad of the display panel 110 in a tape-automated-bonding (TAB) structure or a chip-on-glass (COG) structure, or be directly disposed in the display panel 110 in a gate-in-panel (GIP) structure.

Further, each gate driver integrated circuit may be implemented such that the gate driver integrated circuit is integrated into the display panel 110, or implemented in a chip-on-film (COF) structure where the gate driver integrated circuit is mounted on a film connected to the display panel 110.

The data driver 130 may drive the plurality of data lines DL by supplying data voltages to the plurality of data lines DL.

When one or more specific gate lines are driven by the gate driver 120, the data driver 130 may convert image data received from the controller 140 into data voltages in an analog form and supply the resulting data voltages to the plurality of data lines DL. Thereby, the data driver 130 may drive the plurality of data lines DL.

The data driver 130 may include at least one source driver integrated circuit to drive a plurality of data lines DL.

Each source driver integrated circuit may be electrically connected to a bonding pad of the display panel 110 in the tape-automated-bonding (TAB) structure or in the chip-on-glass (COG) structure, be directly disposed in the display panel 110, or be disposed such that the source driver integrated circuit is integrated into the display panel 110.

Further, each source driver integrated circuit may be implemented in the chip-on-film (COF) structure. In this implementation, a corresponding first edge of each source driver integrated circuit may be bonded to at least one source printed circuit board, and a corresponding second opposing edge may be bonded to the display panel 110.

The controller 140 may supply control signals to the gate driver 120 and the data driver 130, and thereby control the gate driver 120 and the data driver 130.

The controller 140 may start to scan pixels according to respective times set in each frame, convert image data received from an external device or system (e.g., a host system) to a data signal form readable by the data driver 130, then supply image data resulting from the converting to the data driver 130, and control data driving at times set for scanning corresponding one or more pixels.

The controller 140 may receive, in addition to input image data, several types of timing signals including a vertical synchronous signal VSYNC, a horizontal synchronous signal HSYNC, an input data enable signal DE, a clock signal CLK, and the like from the external device or system (e.g., the host system).

In addition to converting image data input from the external device or system into the data signal form readable by the data driver 130 and outputting the image data resulting from the converting to the data driver 130, to control the gate driver 120 and the data driver 130, the controller 140 may generate several types of control signals based on the received timing signals including the vertical synchronous signal VSYNC, the horizontal synchronous signal HSYNC, the input data enable signal DE, the clock signal CLK, and the like, and output the generated control signals to the gate driver 120 and the data driver 130.

For example, to control the gate driver 120, the controller 140 may output several types of gate control signals GCS including a gate start pulse GSP, a gate shift clock GSC, a gate output enable signal GOE, and the like.

Here, the gate start pulse GSP may be used for controlling an operation start time of one or more gate driver integrated circuits included in the gate driver 120. The gate shift clock GSC may be a clock signal commonly input to one or more gate driver integrated circuits and be used for controlling a shift time of a gate signal (or a gate pulse). The gate output enable signal GOE may be used for indicating time information for one or more gate driver integrated circuits.

Further, to control the data driver 130, the controller 140 may output several types of data control signals DCS including a source start pulse SSP, a source sampling clock SSC, a source output enable (SOE) signal, and the like.

Here, the source start pulse SSP may be used for controlling a data sampling start time of one or more source driver integrated circuits included in the data driver 130. The source sampling clock SSC may be a clock signal for controlling a sampling time of data in each source driver integrated circuit. The source output enable signal SOE may be used for controlling an output time of the data driver 130.

The controller 140 may be disposed on a control printed circuit board electrically connected to a source printed circuit board to which one or more source driver integrated circuits are bonded via a connection medium, such as a flexible flat cable FFC, a flexible printed circuit FPC, or the like.

The display device 100 may further include a power controller configured to supply several types of voltages or currents to the display panel 110, the gate driver 120, the data driver 130, and the like, or control several types of voltages or currents to be supplied thereto. The power controller may also be referred to as a “power management integrated circuit”.

Referring to FIG. 1, the display panel 110 may include a display area DA where an image may be displayed. The display area DA may include a normal area NA and an optical area OA. The normal area NA may be a typical area where an image may be displayed. The optical area OA may be an area where one or more sensors or optical devices are disposed. For example, the one or more sensors or optical devices may include a plurality sensors or optical devices, such as at least one camera, at least one image sensor, at least one infrared sensor, and/or the like. A density or resolution of subpixels disposed in the normal area NA may be greater than that of subpixels disposed in the optical area OA. Since at least one sensor or optical device is disposed in the optical area OA, the density or resolution of subpixels disposed in the optical area OA may be designed to be reduced compared with the normal area NA. According to this configuration, a sensing rate or sensing accuracy of the sensor or optical device may be improved.

Subpixels may be disposed in respective areas where gate lines GL and data lines DL intersect in the display panel 110.

Subpixels may be driven by scan signals applied by the gate driver 120 and be configured to present images representing grayscales corresponding to data voltages applied from the data driver 130 based on times at which the scan signals are applied.

Subpixels may include circuit elements, such as transistors and capacitors, and the like, and be designed in various structures depending on design requirements of the display device 100.

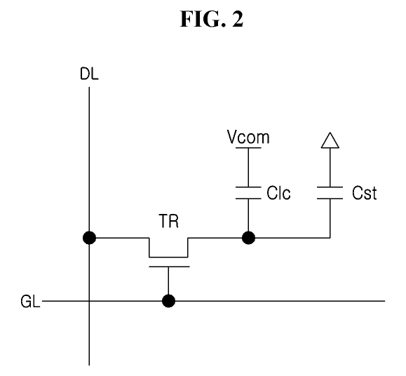

FIG. 2 illustrates an equivalent circuit of a subpixel structure included in the display device 100 according to embodiments of the invention.

Referring to FIG. 2, in one or more embodiments, a subpixel included in the display device 100 may be defined by an area where at least one gate line GL and a data line DL intersect, and include at least one transistor TR, a liquid crystal capacitor Clc, a storage capacitor Cst, and the like.

The transistor TR may be electrically connected between the data line DL and a pixel electrode and be controlled by a signal delivered through the gate line GL.

The transistor TR may be turned on when a scan signal is applied through the gate line GL and may allow a data voltage supplied through the data line DL to be applied to the pixel electrode.

The liquid crystal capacitor Clc may be electrically connected between the pixel electrode and a common electrode, and may be charged by a voltage difference between the data voltage applied to the pixel electrode and a common voltage applied to the common electrode when the transistor TR is turned on.

The storage capacitor Cst may be charged simultaneously with the liquid crystal capacitor Clc, and serve to reduce a voltage drop of the liquid crystal capacitor Clc due to leakage current when the transistor TR is turned off. Thereby, the storage capacitor Cst may enable the subpixel to stably represent grayscales during one frame period.

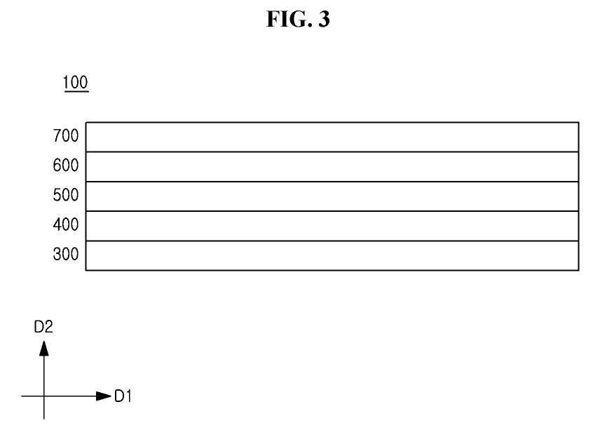

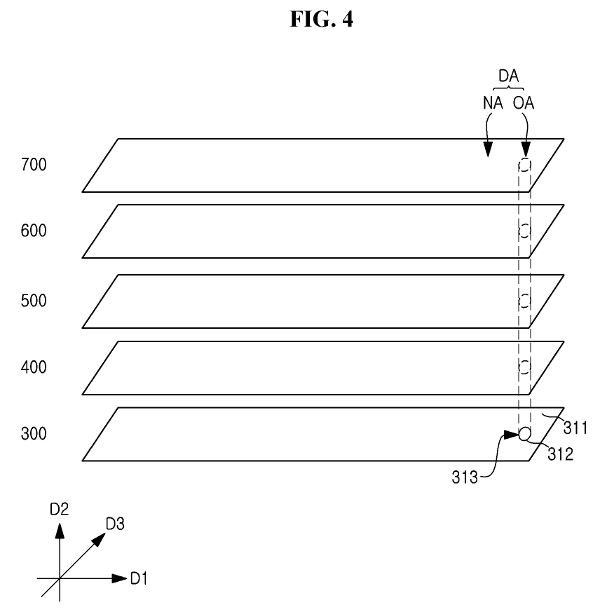

FIGS. 3 and 4 illustrate configurations of the display device 100 according to embodiments of the invention.

The display device 100 may be a liquid crystal display. The display device 100 may include a backlight unit 300, a transistor layer 400, a liquid crystal layer 500, a color filter layer 600, and a polarizing layer 700.

FIG. 3 illustrates a configuration of the display device 100 defined in a first direction D1 and a second direction D2. FIG. 4 illustrates a configuration of the display device 100 defined in a first direction D1, a second direction D2, and a third direction D3. Referring to FIGS. 3 and 4, the display device 100 may have a structure where the backlight unit 300, the transistor layer 400, the liquid crystal layer 500, the color filter layer 600, and the polarizing layer 700 may be sequentially stacked in the second direction D2.

The backlight unit 300 may serve as a light source for the display device 100. The backlight unit 300 may be, but is not limited to, an edge-type backlight unit 300 or a direct-type backlight unit 300. The backlight unit 300 may provide light representing luminance of a same level across the entire front surface of the backlight unit 300. The backlight unit 300 may be driven by a local dimming driving method. When the backlight unit 300 is controlled by the local dimming driving method, the luminance of a specific portion of the backlight unit 300 may be greater or less than that of another portion thereof.

The transistor layer 400 may be a layer for controlling a state of the liquid crystal layer 500. The transistor layer 400 may include components for controlling subpixels. For example, the transistor layer may include a plurality of transistors and a plurality of capacitors. The transistor layer 400 may control the subpixels and thereby adjust a transmittance of the liquid crystal layer 500. The transistor layer 400 may include a plurality of insulating layers and a plurality of metal lines.

The liquid crystal layer 500 may control an amount of light passing through the liquid crystal layer 500. The liquid crystal layer 500 may include a liquid crystal material whose molecular arrangement changes in response to an electric field. The liquid crystal layer 500 may control an amount of light transmitted by adjusting a polarization direction of light according to an external electric field. The alignment of the liquid crystal layer 500 may be performed by any suitable switching configuration, such as fringe-field switching (FFS), vertical alignment (VA), twisted nematic (TN), in-plane switching (IPS), and the like.

The color filter layer 600 may be a layer for changing a color of light. The color filter layer 600 may serve to allow light to have a color. The color filter layer 600 may change a color of light passing through the liquid crystal layer 500. For example, a color of light before passing through the color filter layer 600 may be changed after passing through the color filter layer 600. The color filter layer 600 may include a red color filter, a green color filter, a blue color filter, and the like. The color filter layer 600 may also include a white color filter. It should be understood that in an example where the color filter layer 600 includes a hole, an area where the hole is located may be defined as a white color filter. Colors of light converted by the color filter layer 600 may be red, green, and/or blue. Light produced by the backlight unit 300 may change from white to incomplete white while passing through the transistor layer 400. Accordingly, the color filter layer 600 may be designed to take this situation into account. This may be expressed as a white color filter area or an area of the white color filter.

The polarizing layer 700 may control a polarization direction of light to increase contrast ratio and suppress reflection of external light. The polarizing layer 700 may only transmit light in a specific vibration direction. The display device 100 may include two polarizing plates disposed at different locations in the vertical direction. For example, one of the two polarizing plates may be disposed at a location or area of the display device 100 facing the backlight unit 300 in a cross-sectional view, and the other thereof may be disposed at a location or area of the display device 100 facing a surface opposite to the backlight unit 300 among both surfaces of the liquid crystal layer 500.

Referring to FIG. 4, the backlight unit 300, the transistor layer 400, the liquid crystal layer 500, the color filter layer 600, and the polarizing layer 700 may be sequentially stacked in the second direction D2. FIG. 4 illustrates a display area DA including a normal area NA and an optical area OA.

Referring to FIG. 4, the transistor layer 400 corresponding to the normal area NA and the transistor layer 400 corresponding to the optical area OA may have the same configuration. Further, the liquid crystal layer 500, the color filter layer 600, and the polarizing layer 700 may also have the same configuration in both the normal area NA and the optical area OA.

Referring to FIG. 4, the backlight unit 300 corresponding to the normal area NA may be different from the backlight unit 300 corresponding to the optical area OA. The backlight unit 300 disposed in the optical area OA may include a backlight hole 313. A location of the backlight hole 313 may be overlapped with a location of the optical area OA. An area of the backlight hole 313 may be the same as that of the optical area OA.

Referring to FIG. 4, the backlight unit 300 may include a backlight normal area 311 and a backlight optical area 312. The backlight normal area 311 may correspond to the normal area NA of the display area DA, and the backlight optical area 312 may correspond to the optical area OA of the display area DA. The backlight optical area 312 may be identical to the backlight hole 313.

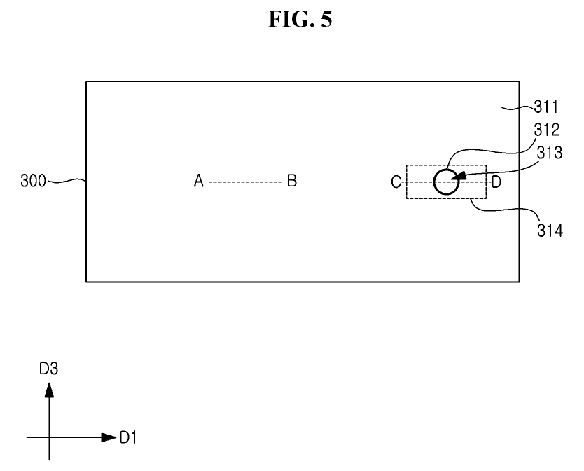

FIG. 5 is a plan view of the backlight unit 300 according to embodiments of the invention.

FIG. 5 illustrates that the backlight unit 300 includes one backlight hole 313. However, the inventive concepts are not limited thereto. For example, the backlight unit 300 may include two or more backlight holes 313. For example, a camera sensor may be overlapped with one backlight hole 313, and an infrared sensor may be overlapped with another backlight hole 313.

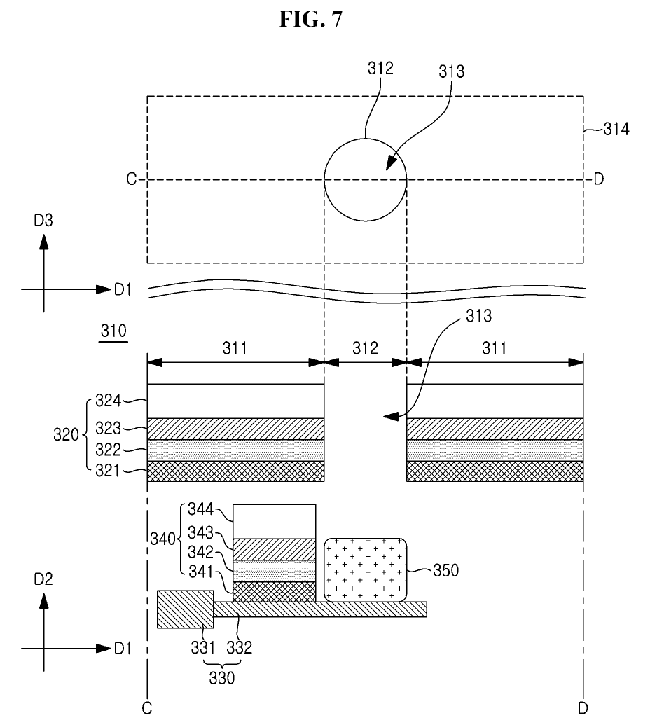

FIG. 5 illustrates that line A-B or an area of line A-B is indicated in the backlight normal area 311. Further, FIG. 5 illustrates that line C-D or an area of line C-D is indicated across the backlight normal area 311 and the backlight optical area 312. An enlarged portion 314 of the backlight unit 300 is illustrated in FIG. 7 for convenience of explanation. Hereinafter, line A-B or an area of line A-B, line C-D or area of line C-D, and an enlarged portion 314 of the backlight unit 300 are described in more detail.

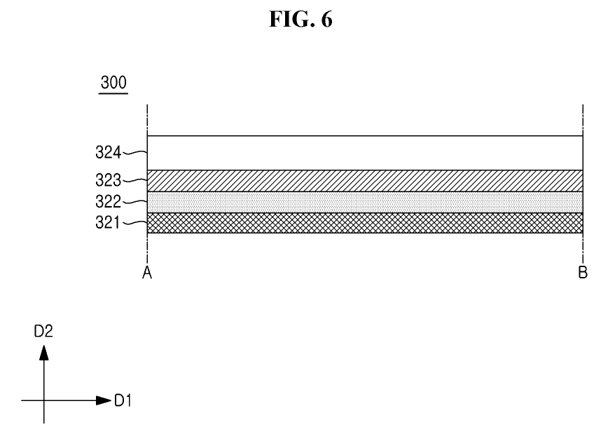

FIG. 6 is a cross-sectional view taken along line A-B of FIG. 5.

Referring to FIG. 6, the backlight unit 300 may include a light source 321, a reflective sheet 322, a light guide plate 323, and a diffusion sheet 324. The light source 321, the reflective sheet 322, the light guide plate 323, and the diffusion sheet 324 may be sequentially stacked in the second direction D2.

Referring to FIG. 6, the light source 321 may supply light to the backlight unit 300. The light source 321 may include a plurality of light emitting elements. The light source 321 may be disposed at an edge or rear surface of the light guide plate 323. For example, the light source 321 may be configured in a direct type, an edge type, or a hybrid type including both the direct type and edge type. The light source 321 may be controlled by a local dimming method.

Referring to FIG. 6, the reflective sheet 322 may reflect light emitted from the light source 321 toward a location in which the light guide plate 323 is disposed without loss of light. The reflective sheet 322 may be disposed between the light guide plate 323 and the light source 321. The reflective sheet 322 may evenly distribute light and increase light efficiency of the backlight unit 300.

Referring to FIG. 6, the light guide plate 323 may serve to evenly diffuse light incident on the light guide plate 323 in a horizontal direction. The light guide plate 323 may include transparent acrylic or polycarbonate. The light guide plate 323 may include fine patterns or dots formed on at least one surface for guiding light upwardly. In an example where the light source 321 is configured in the edge type, the light guide plate 323 may evenly diffuse light emitted from an edge of the light source 321 in a horizontal direction. In an example where the light source 321 is configured in the direct type, since light easily travels toward the front surface of the display device 100, the light guide plate 323 may not be included in the display device 100. In an example where the light guide plate 323 is included in the display device 100 including the light source 321 configured in the direct type, the light guide plate 323 may be disposed on the light source 321.

The diffusion sheet 324 may further diffuse light passing through the light guide plate 323. The diffusion sheet 324 may enable light incident on the diffusion sheet 324 to be uniformly distributed across the entire surface. The diffusion sheet 324 may include a resin layer containing fine scattering particles. The diffusion sheet 324 may include a plurality of sheets. For example, the diffusion sheet 324 may include a diffuser sheet for diffusion, a prism sheet for controlling a direction of light and increasing luminance, a protection sheet for protecting the diffusion sheet 324 and a layer under the diffusion sheet 324, and the like.

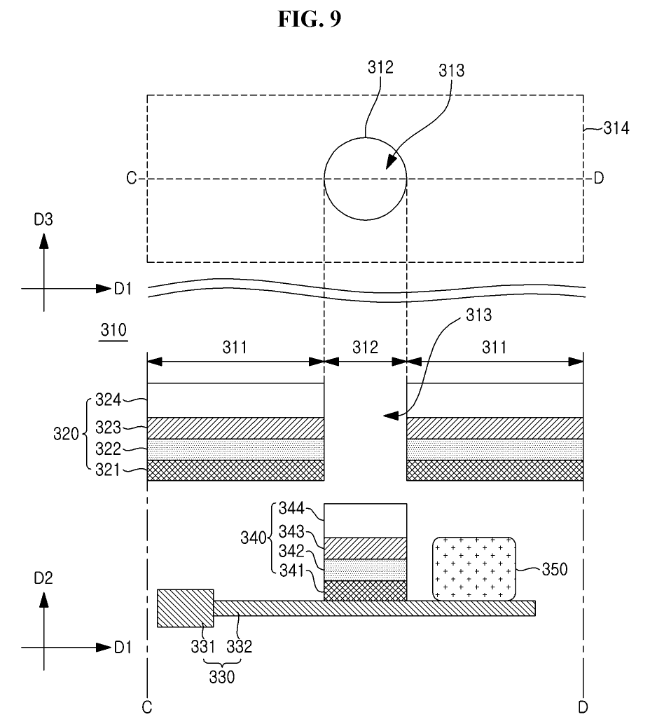

FIGS. 7 and 9 are cross-sectional views taken along line C-D of FIG. 5.

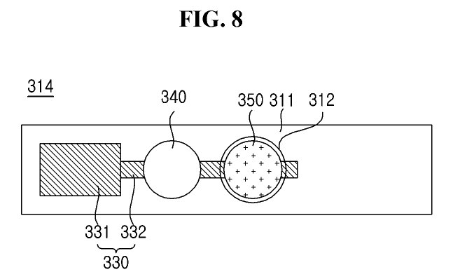

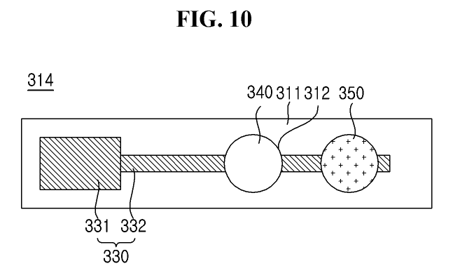

FIGS. 8 and 10 illustrate structures of an area surrounding the optical area OA according to embodiments of the invention.

FIG. 7 illustrates an enlarged portion 314 of the backlight unit 300 and a cross-sectional view taken along line C-D in the backlight unit 300. The enlarged portion 314 of the backlight unit 300 is shown based on the first direction D1 and the third direction D3, and the cross-sectional view taken along line C-D of the backlight unit 300 is shown based on the first direction D1 and the second direction D2.

Referring to FIG. 7, the light source 321, the reflective sheet 322, the light guide plate 323, and the diffusion sheet 324 shown in FIG. 7 may have the same configuration as the light source 321, the reflective sheet 322, the light guide plate 323, and the diffusion sheet 324 shown in FIG. 6. The light source 321, the reflective sheet 322, the light guide plate 323, and the diffusion sheet 324 may be included in a normal emission module 320.

Referring to FIG. 7, the backlight unit 300 may further include a position control device 330, an optical emission module 340, and an optical sensor module 350.

The position control device 330 may control respective positions of the optical emission module 340 and the optical sensor module 350.

The optical emission module 340 and the optical sensor module 350 may be disposed on the position control device 330.

Referring to FIG. 7, the optical emission module 340 may be located adjacent to the optical sensor module 350.

Although FIG. 7 illustrates that the optical emission module 340 is located to the left of the optical sensor module 350, however, the location of the optical emission module 340 may be switched with that of the optical sensor module 350.

The position control device 330 may be controlled by the controller 140 of the display device 100. However, the inventive concepts are not limited thereto. For example, the backlight unit 300 may include a separate controller, and this controller may control the position control device 330.

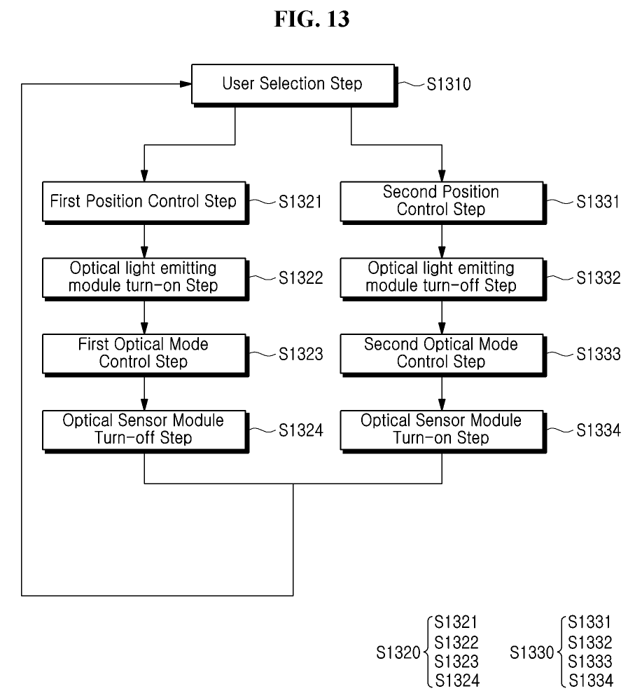

The position control device 330 may position the optical sensor module 350 in the optical area OA during an optical driving period. In this situation, the optical emission module 340 may not be positioned in the optical area OA. The optical driving period may mean a second optical mode step S1330 illustrated in FIG. 13.

The position control device 330 may position the optical emission module 340 in the optical area OA during a normal driving period. In this situation, the optical sensor module 350 may not be positioned in the optical area OA. The normal driving period may mean a first optical mode step S1320 illustrated in FIG. 13.

Referring to FIG. 7, the optical emission module 340 may include an optical light source 341, an optical reflective sheet 332, an optical light guide plate 343, and an optical diffusion sheet 344.

Referring to FIG. 7, the optical light source 341, the optical reflective sheet 332, the optical light guide plate 343, and the optical diffusion sheet 344 may be sequentially stacked in the second direction D2.

The features of the optical light source 341 illustrated in FIG. 7 may be the same as those of the light source 321 illustrated in FIG. 6. The optical light source 341 may include one or more light emitting elements. For example, the one or more light emitting elements may be LEDs, mini-LEDs, micro-LEDs, or the like.

Referring to FIG. 7, the normal optical module 320 may be a normal backlight unit including a hole 313, and the optical emission module 340 may be configured to emit light into the hole 313. Therefore, the shape, diameter, size, and the like of the optical emission module 340 may be designed based on the backlight hole 313.

Referring to FIG. 7, a size of the optical emission module 340 may be smaller than that of the normal emission module 320. For example, referring to FIG. 7, a length of the optical emission module 340 in the first direction D1 may be less than that of the normal emission module 320 in the first direction D1.

Therefore, the optical emission module 340 may include a light emitting element with a smaller size than the normal emission module 320. For example, the normal emission module 320 may include at least one LED, a linear-type emission body to which a plurality of LEDs are connected, and/or the like, and the optical emission module 340 may include at least one mini LED.

Referring to FIG. 7, a location of the optical emission module 340 may be lower than that of the normal emission module 320. For example, a location of the optical emission module 340 may be movable under the normal emission module 320.

The light source 321 of the normal emission module 320 may be configured in the direct type, edge type, or hybrid type. The optical emission module 340 may be configured in the direct type, edge type, or hybrid type. Considering a small size of the backlight hole 313 in which the optical emission module 340 is located, the optical emission module 340 may be designed to have the direct type.

The characteristics of the optical reflective sheet 332 may be the same as those of the reflective sheet 322 illustrated in FIG. 6. The characteristics of the optical light guide plate 343 may be the same as those of the light guide plate 323 illustrated in FIG. 6. The characteristics of the optical diffusion sheet 344 may be the same as those of the optical sheet illustrated in FIG. 6. In an example where the optical light source 341 of the optical emission module 340 is configured in the edge type or hybrid type, the optical light guide plate 343 may be disposed on the optical light source 341. In an example where the optical light source 341 of the optical emission module 340 is configured in the direct type, the optical light guide plate 343 may not be disposed on the optical light source 341. For example, the optical light guide plate 343 may be disposed on the optical light source 341 according to a design requirement. In an example where the optical light guide plate 343 is not disposed on the optical light source 341, a size of the optical emission module 340 may be designed to be smaller. Accordingly, a slimmer or thinner backlight unit 300 may be realized.

The optical sensor module 350 may be a camera sensor, an infrared sensor, and the like, but the inventive concepts are not limited thereto.

FIG. 7 illustrates the backlight hole 313 shown in the enlarged portion 314 of the backlight unit 300 and the backlight hole 313 illustrated in the cross-sectional view taken along line C-D of the backlight.

Although FIG. 7 illustrates the backlight hole 313 having a circlular shape, however, the inventive concepts are not limited thereto. For example, the backlight hole 313 may be a perfect circle or a perfect ellipse. The backlight hole 313 may appear to be circular overall, but include a plurality of curved portions. The backlight hole 313 may be a shape where a plurality of curved straight lines are connected.

An area of the normal emission module 320 corresponding to the backlight hole 313 may be left in a removed state. The normal emission module 320 may not be disposed in the area corresponding to the backlight hole 313. A portion of the normal emission module 320 corresponding to the optical area OA may be left in a removed area. According to this configuration, when the optical sensor module 350 is positioned in an area of the backlight hole 313, a sensing rate of the optical sensor module 350 may be increased.

Referring to FIG. 7, the position control device 330 may include a control motor 331 and a rail 332. The control motor 331 may control a position of the rail 332. The rail 332 may fix positions of the optical emission module 340 and the optical sensor module 350. Because the optical emission module 340 and the optical sensor module 350 are arranged on the rail 332, and a position of the rail 332 is controlled, the optical emission module 340 or the optical sensor may be positioned in the optical area OA.

Referring to FIGS. 7 and 8, the position control device 330 may control the optical sensor module 350 to be positioned in the optical area OA. In this situation, the optical sensor module 350 may detect an external signal or external event through the optical area OA. In this situation, the optical emission module 340 may be in a state where light is not emitted.

Referring to FIGS. 9 and 10, the position control device 330 may control the optical emission module 340 to be positioned in the optical area OA. In this situation, the optical emission module 340 may emit light to the optical area OA. An image may be displayed in the optical area OA based on the light emitted from the optical emission module 340.

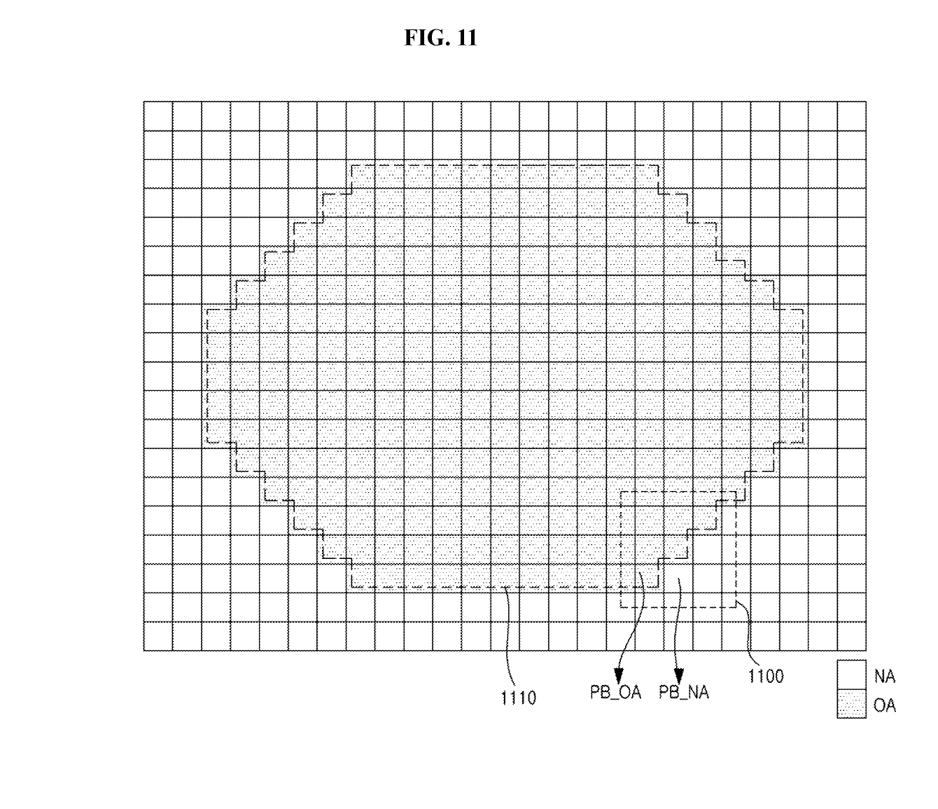

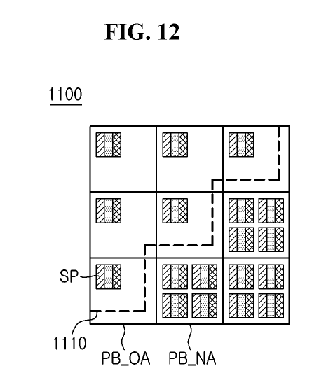

FIGS. 11 and 12 illustrate an area surrounding the optical area OA according to embodiments of the invention.

FIG. 11 illustrates the normal area NA and the optical area OA.

Referring to FIG. 11, one or more normal pixel blocks PB_NA may be disposed in the normal area NA.

Referring to FIG. 11, one or more optical pixel blocks PB_OA may be disposed in the optical area OA.

FIG. 11 illustrates a solid dotted line drawn in the optical area OA adjacent to the normal area NA. This dotted line may be a line dividing the normal area NA and the optical area OA, and be defined as an optical boundary line 1110. Referring to FIG. 11, the optical boundary line 1110 may be located in the optical area OA.

FIG. 11 illustrates a plurality of normal pixel blocks PB_NA and a plurality of optical pixel blocks PB_OA are disposed along the optical boundary line 1110. FIG. 12 illustrates an enlarged view of an area around the optical boundary line 1110.

FIG. 12 illustrates normal pixel blocks PB_NA and optical pixel blocks PB_OA.

Referring to FIG. 12, four subpixels SP may be disposed in a normal pixel block PB_NA, and one subpixel SP may be disposed in an optical pixel block PB_OA. For example, the number and density of subpixels SP disposed in the normal pixel blocks PB_NA may be greater than the number and density of subpixels SP disposed in the optical pixel blocks PB_OA. For example, the resolution of the normal pixel blocks PB_NA may be greater than the resolution of the optical pixel blocks PB_OA.

FIG. 12 illustrates that one subpixel SP is disposed in an upper left corner of the optical pixel block PB_OA, and no subpixel SP is disposed in the remaining area. Thus, since no subpixel SP is disposed in the remaining area, the density of subpixels SP disposed in the optical pixel block PB_OA may be reduced. Accordingly, a transmittance of the optical area OA may increase, and a sensing rate of the optical sensor module 350 for the optical area OA may be improved.

Referring to FIG. 12, the optical boundary line 1110 may be located in the following conditions. The optical boundary 1110 may be located in optical pixel blocks PB_OA, and more specifically, be located in the optical pixel blocks PB_OA adjacent to normal pixel blocks PB_NA. Further, the optical boundary 1110 may be located between a subpixel SP of each optical pixel block PB_OA and subpixels SP of each normal pixel block PB_NA. FIG. 12 illustrates the optical boundary line 1110 drawn in a zigzag shape.

For example, while being located in optical pixel blocks PB_OA, the optical boundary line 1110 may be located between optical pixel blocks PB_OA and normal pixel blocks PB_NA. When the optical boundary line 1110 is located between subpixels SP of normal pixel blocks PB_NA and subpixels SP of other normal pixel blocks PB_NA, a black line may appear on the optical area OA, and thereby, image quality may be degraded. In contrast, because the optical boundary line 1110 is located in optical pixel blocks PB_OA adjacent to normal pixel blocks PB_NA, the display device may provide an advantage of further improving the image quality of the display device 100.

A shape of the optical emission module 340 illustrated in FIGS. 7-10 may be the same as that of the optical area OA. For example, when the optical area OA is circular, the shape of the optical emission module 340 may be circular. When the optical area OA is elliptical, the shape of the optical emission module 340 may be elliptical. When the optical area OA has a shape similar to the elliptical shape illustrated in FIG. 11, the shape of the optical emission module 340 may also be designed to have a shape similar to the elliptical shape.

For example, since the shape of the optical emission module 340 is the same as that of the optical area OA, a clear image may be displayed on the optical area OA.

FIG. 13 is a flow chart illustrating a driving method of the display device 100 according to embodiments of the invention.

A method of driving the display device 100 may include a user selection step 1310, a first optical mode step S1320, and a second optical mode step S1330.

The user selection step 1310 may be a step in which a user selects a first optical mode or a second optical mode. For example, the user selection step 1310 may be a step in which the display device 100 is selected to be driven from the first optical mode to the second optical mode. Further, the user selection step 1310 may be a step in which the display device 100 is selected to be driven from the second optical mode to the first optical mode.

The first optical mode step S1320 may be a step in which the controller 140 controls the optical emission module 340 to be positioned in the optical area OA.

The second optical mode step S1330 may be a step in which the controller 140 controls the optical sensor module 350 to be positioned in the optical area.

The first optical mode step S1320 may include a first position control step S1321, an optical emission module turn-on step S1322, a first optical mode control step S1323, and an optical sensor module turn-off step S1324.

The first position control step S1321 may be a step in which the controller 140 controls the position control device 330. In the first position control step S1321, the controller 140 may control a position of the position control device 330. Thereby, the optical emission module 340 may be positioned in the optical area OA.

The optical emission module turn-on step S1322 may be a step in which the optical emission module 340 is turned on. Because the optical emission module 340 is turned on, light may be emitted into the optical area OA.

The first optical mode control step S1323 may be a step for controlling the luminance of the display device 100 to become uniform. In the first optical mode control step S1323, the controller 140 may control luminance of the normal area NA and luminance of the optical area OA to become uniform. Since a transmittance of the optical area OA is higher than that of the normal area NA, the controller 140 may be needed to control the luminance of the display device 100 by taking the transmittance of the optical area OA into consideration. For example, the following control may be performed.

In the first optical mode control step S1323, the controller 140 may control the luminance of the optical emission module 340 to be lower than the luminance of the normal emission module 320. Since the luminance of the optical area OA, which has a high transmittance, becomes lower than the luminance of the normal area NA, which has a low transmittance, the luminance of the optical area OA and the luminance of the normal area NA may become uniform.

In the first optical mode control step S1323, the controller 140 may control a transmittance of the liquid crystal layer 500 for each area. For example, the controller 140 may control a transmittance of the liquid crystal layer 500 for each area where a corresponding subpixel SP is disposed. The controller 140 may also control a transmittance of the liquid crystal layer 500 for each area where a corresponding pixel is disposed. A transmittance of the liquid crystal layer 500 of an optical pixel block PB_OA may be lower than that of the liquid crystal layer 500 of a normal pixel block PB_NA. Controlling the transmittance of the liquid crystal layer 500 may refer to a degree to which a shape of the liquid crystal arrangement of the liquid crystal layer 500 is changed.

The optical sensor module turn-off step S1324 may be a step in which the optical sensor module 350 is turned off. In the optical sensor module turn-off step S1324, the controller 140 may control the optical sensor module 350 to be turned off. Because the optical sensor module 350 is turned off, an undesired operation of the optical sensor module 350 may be prevented.

The second optical mode step S1330 may include a second position control step S1331, an optical emission module turn-off step S1332, a second optical mode control step S1333, and an optical sensor turn-on step S1334.

The second position control step S1331 may be a step in which the controller 140 controls the position control device 330. In the second position control step S1331, the controller 140 may control a position of the position control device 330. Thereby, the optical sensor module 350 may be positioned in the optical area OA.

The optical emission module turn-off step S1332 may be a step in which the optical emission module 340 is turned off. Because the optical emission module 340 is turned off, an undesired operation of the optical emission module 340 may be prevented.

The second optical mode control step S1333 may be a step in which a transmittance of the liquid crystal layer 500 is controlled. In the second optical mode control step S1333, the controller 140 may control the liquid crystal layer 500 to control the transmittance of the liquid crystal layer 500. Since the optical sensor module 350 detects light, the higher a transmittance of the liquid crystal layer 500 is, the higher a sensing rate of the optical sensor module 350 is.

For example, in the second optical mode control step S1333, the transistor layer 400 may control the entire liquid crystal layer 500 to have the highest transmittance. Thereby, the liquid crystal layer 500 may be in the highest transmittance state. For example, the liquid crystal layer 500 corresponding to the optical area OA may be in the highest transmittance state.

For example, in the second optical mode control step S1333, the transistor layer 400 may control a transmittance of the liquid crystal layer 500 overlapping with an area not overlapped with the color filter to increase. In this example, a transmittance of the liquid crystal layer 500 overlapped with the color filter may be controlled to decrease. For example, the liquid crystal layer 500 corresponding to the optical area OA may be controlled to remain at a low transmittance in areas overlapped with a red color filter, a green color filter, and a blue color filter. In this example, the liquid crystal layer 500 corresponding to the optical area OA may be controlled to remain at a high transmittance in an area overlapped with the area of a white color filter.

The optical sensor turn-on step S1334 may be a step in which the optical sensor module 350 is turned on. In the optical sensor turn-on step S1334, the controller 140 may control the optical sensor module 350 to be turned on.

After the optical sensor turn-off step or the optical sensor turn-on step S1334 is performed, the user selection step 1310 may be performed again. For example, the driving method of the display device 100 may be repeatedly performed while the display device 100 is being driven through a feedback method.

According to the inventive concepts described herein, the display device 100 is capable of sensing an optical device in the display area DA through the position control device 330, the optical emission module 340, and the optical sensor module 350.

According to the inventive concepts described herein, the display device 100 is capable of being packaged with a reduced thickness through the position control device 330, the optical emission module 340, and the optical sensor module 350.

According to the inventive concepts described herein, the display device 100 may be provided that is capable of improving quality of display images through the position control device 330, the optical emission module 340, and the optical sensor module 350.

According to the inventive concepts described herein, the display device 100 may be provided that is capable of improving quality of display images and being driven with low power through the position control device 330, the optical emission module 340, and the optical sensor module 350.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a backlight unit configured to provide backlight illumination; and
a liquid crystal layer disposed over the backlight unit and including a plurality of liquid crystals whose arrangements are changeable,
wherein the backlight unit comprises:
a normal emission module including an optical area and a normal area surrounding the optical area;
an optical emission module positioned in the optical area or the normal area;
an optical sensor module configured to sense an external signal or external event through the optical area; and
a position control device configured to control positions of the optical emission module and the optical sensor module and position the optical emission module or the optical sensor module in the optical area.

2. The display device of claim 1, wherein the position control device is configured to position the optical emission module in the optical area in a first optical mode step and position the optical sensor module in the optical area in a second optical mode step different from the first optical mode step.

3. The display device of claim 1, wherein the optical emission module of the backlight unit is located closer to the optical sensor module than the normal emission module.

4. The display device of claim 1, wherein the position control device further comprises:
a rail to which the optical emission module and the optical sensor module are fixed; and .
a control motor configured to control a position of the rail.

5. The display device of claim 1, further comprises:
at least one normal pixel block located in the normal area; and
at least one optical pixel block located in the optical area,
wherein a number of subpixels located in one optical pixel block is less than a number of subpixels located in one normal pixel block.

6. The display device of claim 5, further comprising: a color filter layer disposed on the liquid crystal layer, and the color filter layer including a plurality of color filters,
wherein a number of the color filters located in the at least one optical pixel block is less than a number of the color filters located in the at least one normal pixel block.

7. The display device of claim 5, wherein a planar shape of the optical emission module is the same as a shape of a boundary between a plurality of the optical pixel blocks and a plurality of the normal pixel blocks.

8. The display device of claim 1, wherein a planar shape of the optical emission module is the same as a planar shape of the optical area.

9. The display device of claim 1, wherein the optical emission module further comprises:
an optical light source configured to emit light;
an optical reflective sheet located on the optical light source and reflecting a direction of the light;
an optical light guide plate located on the optical reflective sheet and diffusing the light; and
an optical diffusion sheet located on the optical light guide plate and re-diffusing the light.

10. The display device of claim 1, wherein:
the optical sensor module is a camera sensor or an infrared sensor;
the normal emission module comprises a backlight hole corresponding to the optical area; and
the optical sensor module is overlapped with the backlight hole.

11. A driving method of a display device, the driving method comprising:
a first optical mode step of positioning an optical emission module in an optical area and positioning an optical sensor module in a normal area surrounding the optical area; and
a second optical mode step of positioning the optical sensor module located adjacent to the optical emission module in the optical area and positioning the optical emission module in the normal area.

12. The driving method of claim 11, wherein the first optical mode step further comprises:
a first position control step of positioning the optical emission module in the optical area;
an optical emission module turn-on step of turning on the optical emission module;
a first optical mode control step of compensating for luminance of the optical area; and
an optical sensor module turn-off step of turning off the optical sensor module.

13. The driving method of claim 12, wherein, in the first position control step, a controller controls a position control device to allow the optical emission module to be positioned in the optical area.

14. The driving method of claim 12, wherein, in the first optical mode control step, an intensity of light emitted from a light source of the optical emission module is less than an intensity of light emitted from a light source of a normal emission module located in the normal area.

15. The driving method of claim 12, wherein, in the first optical mode control step, a transmittance of a liquid crystal layer located in the optical area is less than a transmittance of a liquid crystal layer located in the normal area.

16. The driving method of claim 11, wherein the second optical mode step further comprises:
a second position control step of positioning the optical sensor module in the optical area;
an optical emission module turn-off step of turning off the optical emission module;
a second optical mode control step of controlling a transmittance of a liquid crystal layer of the optical area; and
an optical sensor module turn-on step of turning on the optical sensor module.

17. The driving method of claim 16, wherein, in the second position control step, a controller controls a position control device to allow the optical sensor module to be positioned in the optical area.

18. The driving method of claim 16, wherein:
in the second optical mode control step, a transmittance of the liquid crystal layer of the optical area is controlled to be maximum; and
in the second position control step, the optical sensor module positioned in the optical area is turned on in the optical sensor module turn-on step.

19. The driving method of claim 16, wherein in the second optical mode control step, a transmittance of a portion overlapped with the color filter layer among portions of the liquid crystal layer of the optical area is less than a transmittance of a portion not overlapped with the color filter layer among the portions of the liquid crystal layer of the optical area.

20. A backlight unit comprising:
a normal emission module including an optical area and a normal area surrounding the optical area;
an optical emission module configured to be positioned in the optical area or the normal area;
an optical sensor module configured to sense an external signal or external event through the optical area; and
a position control device configured to control positions of the optical emission module and the optical sensor module in a structure where locations of the optical emission module and the optical sensor module are fixed to each other and position the optical emission module or the optical sensor module in the optical area.
